(19) United States
(12) Patent Application Publication
(10) Pub. No.: US 2004/0049738 A1
(43) Pub. Date: Mar. 11, 2004

(54) Computer implemented system and method of transforming a source file into a transfprmed file using a set of trigger instructions

(76) Inventors: Robert James Cullen Thompson, New South Wales (AU); Stephen Sebastian Peruch, New South Wales (AU)

Correspondence Address: HENRICKS SLAVIN AND HOLMES LLP, SUITE 200, 840 APOLLO STREET, EL SEGUNDO, CA, 90245

(21) Appl. No.: 10/362,032

(22) PCT Filed: Aug. 17, 2001
(86) PCT No.: PCT/AU01/01020

(30) Foreign Application Priority Data
Aug. 17, 2000 (AU) PQ9504

(51) Int. Cl. G06F 17/00

(52) U.S. Cl. 715/513

(57) ABSTRACT

A computer implemented method of defining a set of trigger instructions corresponding to a source file type, the source file type including a plurality of data segments and the method including the steps of: receiving a source file having a source file type; displaying the source file; selecting one of the data segments; defining a data segment trigger instruction corresponding to that selected data segment; and storing that data segment trigger instruction in a trigger instruction store.

### FIELD OF THE INVENTION

The present invention relates to a computer implemented system and method of transforming a source file into a transformed file using a set of trigger instructions and, in particular to a system and method for transforming a poorly structured source file, such as a printer file, into a highly structured transformed file, such as an XML (Extensible Markup Language) file using a set of predefined trigger instructions. Once transformed, the file can then be converted into any number of different formats and delivered via a variety of means to a number of destinations.

The invention has been developed primarily for use in facilitating business to business and e-commerce transactions and application to application communication and will be described hereinafter with reference to this application. However, it will be appreciated that the invention is not limited to this particular field of use.

### BACKGROUND ART

Any discussion of the prior art throughout the specification should in no way be considered as an admission that such prior art is widely known or forms part of common general knowledge in the field.

Data translation from one software application to another is a common practice in computing. Generally, an application will output data in a given format that a similar application can input without requiring conversion.

Example 1: Output A=>Input B In this example no translation is required.

It is common practice, however, to use a customised translator to translate data from one form to another when data formats are incompatible.

Example 2: Output A=>Customised TRANSLATOR=>Input B. In this example translation is required.

These customised translators can be specifically developed for particular translation tasks or a generic translator can be used to translate from one generic data format to another.

Example 3: Output A=>Generic TRANSLATOR=>Input B. In this example translation is required.

With the maturing of electronic commercial trading via the Internet, companies wishing to electronically trade with one another need to translate data from their own host application output to the data format required by the applications used by their trading partners. Traditionally, organisations have done this by developing customised translators as in Example 2 or by using generic translators as in Example 3, or by using a common data format that requires no intermediate translators, as in Example 1.

The actual situation with most organisations is that most systems output somewhat incompatible data and therefore some translation is usually necessary.

When organisations wish to conduct automated electronic business transactions with their trading partners, complications are faced when an organisation that has 100 trading partners may therefore need up to 100 different translators to trade electronically with them. This impractical scenario led to the development of protocols to facilitate electronic business transaction such as EDI (Electronic Data Interchange) type standards that define generic data formats and procedures that describe and facilitate a given transaction type. Under this scenario, in order to exchange data correctly, all participating trading partners adopt the same generic data format, translators, and protocols. This is illustrated in Example 4 below.

Example 4: Output A=>Generic EDI TRANSLATOR for purchase orders=>Input B. In this example, EDI translation is required.

These EDI standards tend to be complex, proprietary in nature and expensive to maintain and administer. These limitations have led to the exclusion of many smaller businesses from participating in EDI type transactions.

Consequently, the vast bulk of transactions of small to medium size enterprises are still document based, that is, by paper or faxed transmissions.

In recent years, the members of the World Wide Web Consortium (W3C), an organisation created to promote the development of common protocols for the World Wide Web, issued recommendations for XML. Amongst other things, XML was developed to facilitate electronic transactions using a Document approach to handling data. Along with SGML (Standard Generalised Markup Language) and HTML (Hyper Text Markup Language), XML was considered to be an ideal format for not only storing simple or very complex relationships between data, but also for describing the structure and meaning of data that the XML file contains. The fact that XML has been specifically designed to integrate with other existing WEB and Internet technologies, when coupled with the fact that its protocols are non proprietary, makes XML a very important technology for electronic business transactions. As such, many new developments are taking place that allow transactions in XML format to facilitate electronic trading. XML data can easily be transformed from one state to the next. It can be graphically formatted and deployed and delivered via many means. Proponents of XML claim that most of the problems and costs of doing business electronically can be solved with XML based technology. However, the introduction of XML has created a number of new problems.

Firstly, because XML was first recommend in February 1998, many organisations at that time used software applications that did not output or input XML data. The same is true today, such that many organisations have difficulty connecting their systems to XML enabled technology. In most cases customised translators need to be developed to enable these applications to communicate with XML enabled partners.

Secondly, many older systems use internal database technology that can not be easily accessed by newer e-commerce software applications. Therefore, new Internet based transaction technologies that require database connectivity cannot readily connect to these systems.

Thirdly, many application vendors have not yet developed strategies to implement XML technology into their systems. This is forcing many organisations, which rely on these applications, to wait until these applications have introduced XML compatibilities before they can implement electronic trading.

Fourthly, these and other incompatibilities are forcing some users to operate dual applications. For example, many companies need to operate their existing host application that handles business transactions using traditional methods such as fax, print, mail, as well as a second system that is e-commerce enabled, that hosts Internet based electronic trading.

Fifthly, as existing commercial transaction technology is very expensive to implement or complex to administer, smaller trading partners can not afford to purchase current web based trading technologies and will therefore continue to rely upon traditional paper based transactions for some time to come. Alternatively, they will be forced by larger partners to use their centralised web site for electronic trading. This provides cost savings for the larger partners who have the support infrastructure to administer such a commercial web site. However, it creates twice as much work for the smaller or less IT sophisticated companies. This is because if an organisation places orders via a partner's web site, it must then recreate (and usually re-key) that transaction in their own business systems for their own records.

Sixthly, many companies will continue to use paper-based systems for many years to come. Therefore a company will need to continue to output a combination of paper-based transaction, fax based transactions and electronic based transactions whilst managing the many types of corresponding distribution systems. Therefore, a complete switch to purely electronic trading is unlikely for most enterprises.

### DISCLOSURE OF THE INVENTION

It is an object of the present invention to provide a computer implemented system and method of transforming a source file into a transformed file using a set of trigger instructions which will overcome or substantially ameliorate at least some of these deficiencies of the prior art.

In addition, the present invention has a number of non-limiting advantages, as follows:

Firstly, the present invention uses standard poorly structured data commonly produced by host legacy application systems and applies structure and meaning to that data without needing to develop costly customised translators or to substantially modify the host application.

Secondly, the present invention provides a generic software application and method that enables older computer systems to enhance their current output data to make it suitable for electronic trading without needing to write complex translation applications. This allows companies using such systems to take advantage of electronic trading sooner.

Thirdly, the present invention enables an organisation to use their existing processes for e-commerce. For example, an organisation that currently processes and prints an invoice to paper, can use the same process to print to the present invention. The present invention then adds the structure and meaning to the print data, making it suitable for e-commerce transactions, and redirects it to an appropriate down stream e-business process.

Fourthly, the inventor of the present application has perceived the need for software developers to continue to support old business processes based on paper transactions whilst supporting new e-commerce applications for more technically advanced companies. By using this invention a company can continue to process business transactions within their current systems and transmit a business document in the format which their larger partner's web site requires, thereby avoiding duplication of processes.

According to a first aspect of the present invention there is disclosed a computer implemented method of defining a set of trigger instructions corresponding to a source file type, the source file type including a plurality of data segments and the method including the steps of:

(a) receiving a source file having a source file type;

(b) displaying the source file;

(c) selecting one of the data segments;

(d) defining a data segment trigger instruction corresponding to that selected data segment; and

(e) storing that data segment trigger instruction in a trigger instruction store.

Preferably the trigger instruction store is in a file, such as an XML file, although other storage means such as a database may be employed.

Preferably, the set of trigger instructions includes data segment trigger instructions, source file type trigger instructions, function calls, statement calls, regional definitions, conditional statements, annotations and processing instructions.

Preferably, the above method further includes the additional steps of repeating steps (c) to (e) until a plurality of the data segments each have a corresponding data segment trigger instruction.

Preferably, the step of defining the data segment trigger instruction corresponding to that selected data segment includes the steps of:

(a) identifying location information corresponding to that selected data segment; and

(b) defining structural information corresponding to that selected data segment.

Preferably, the step of identifying location information corresponding to that selected data segment includes the step of receiving the location information from a user.

Alternatively, the step of identifying location information corresponding to that selected data segment includes the step of extracting the location information from the source file.

Preferably, the data segment location information includes one or more of:

(i) data segment position information; or

(ii) data segment pattern information.

Preferably, the step of selecting one of the data segments is performed in response to a user supplied data segment selection.

Preferably, the step of defining structural information corresponding to that selected data segment includes the step of receiving the structural information from a user.

Preferably, the structural information includes one or more of:

(i) data segment names;

(ii) data segment attribute settings; or

(iii) data segment hierarchical positioning information.

Preferably, the step of defining a data segment trigger instruction corresponding to that selected data segment is achieved using a trigger mapping tool.

Preferably, the above method further includes the additional steps of:

(a) defining source file type trigger instructions corresponding to the source file type;

(b) storing these instructions in the trigger instruction store.

Preferably, the source file type trigger instructions include instructions relating to one or more of:

(i) transformed file delivery information;

(ii) transformed file conversion information;

(iii) transformed file encryption values;

(iv) transformed file elements;

(v) transformed file attributes;

(vi) transformed file namespaces;

(viii) transformed file data types;

(ix) transformed file data values; or

(x) conditional statements that call other region trigger groups or triggers.

Preferably, the step of converting the transformed file into one or more object files in accordance with the conversion information includes the step of converting the transformed file into one or more object files in one or more of the following formats:

(a) XML format;

(b) facsimile format;

(c) email format;

(d) printing format;

(e) HTML format;

(f) PDF format;

(g) FTP format;

(h) EDI format;

(i) pre-printed form format;

(j) unprinted form format;

(k) graphic file format; or

(l) an application program format.

Preferably, the application program format includes one or more of:

(a) word processor format;

(b) spreadsheet format;

(c) database format;

(d) accounting software format;

(e) graphic software format;

(f) invoice processing software format;

(g) Financial Management Information Systems (FMIS) software;

(h) Enterprise Resource Planning (ERP) software;

(i) Customer Resource Management systems (CRM) software;

(j) Human Resources (HR) systems software; or

(k) Manufacturing systems software.

Preferably, the destinations include one or more of:

(a) email addresses;

(b) facsimile numbers;

(c) postal addresses;

(d) target printers;

(e) IP addresses;

(f) system directories; or

(g) message queues.

According to a second aspect of the present invention there is disclosed a computer implemented system for defining a set of trigger instructions corresponding to a source file type, the source file type including a plurality of data segments and the system including:

(a) a receiver which receives a source file having a source file type;

(b) a display which displays the source file;

(c) a selector which selects one of the data segments;

(d) a definer which defines a data segment trigger instruction corresponding to that data segment; and

(e) storage means which stores that data segment trigger instruction in a trigger instruction store.

Preferably, the set of trigger instructions includes data segment trigger instructions, source file type trigger instructions, function calls, statement calls, conditional statements and processing instructions.

Preferably, the above system can be repeatedly used until a plurality of data segments each have a corresponding data segment trigger instruction.

Preferably, the definer which defines the data segment trigger instruction corresponding to that selected data segment does the following:

(a) identifies location information corresponding to that selected data segment; and

(b) defines structural information corresponding to that selected data segment.

Preferably, the system identifies location information corresponding to that selected data segment by receiving the location information from a user.

Alternatively, the system identifies location information corresponding to that selected data segment by extracting the location information from the source file.

Preferably, the data segment location information includes one or more of:

(i) data segment position information; or

(ii) data segment pattern information.

Preferably, the selector selects one of the data segments in response to a user supplied data segment selection.

Preferably, the definer defines structural information corresponding to that selected data segment by receiving the structural information from a user.

Preferably, the structural information includes one or more of:

(i) data segment names;

(ii) data segment attribute settings;

(iii) data segment hierarchical positioning information; or

(iv) data segment value.

Preferably, the definer is a trigger mapping tool.

Preferably, the above system also:

(a) defines source file type trigger instructions corresponding to the source file type; and

(b) stores these instructions in the trigger instruction store, such as a XML file or a database, for example.

Preferably, the source file type trigger instructions include instructions relating to one or more of:

(i) transformed file delivery information;

(ii) transformed file conversion information;

(iii) transformed file encryption values;

(iv) transformed file elements;

(v) transformed file attributes;

(vi) transformed file namespaces;

(vii) transformed file data types; or

(viii) transformed file data values.

Preferably, the transformed conversion information includes conversion information relating to one or more of the following formats:

(a) XML format;

(b) facsimile format;

(c) email format;

(d) printing format;

(e) HTML format;

(f) PDF format;

(g) FTP format;

(h) EDI format;

(i) pre-printed form format;

(j) unprinted form format;

(k) graphic file format; or

(l) an application program format.

Preferably, the application program format includes one or more of:

(a) word processor format;

(b) spreadsheet format;

(c) database format;

(d) accounting software format;

(e) graphic software format;

(f) invoice processing software format;

(g) Financial Management Information Systems (FMIS) software;

(h) Enterprise Resource Planning (ERP) software;

(i) Customer Resource Management systems (CRM) software;

(j) Human Resources (HR) systems software;

(k) Manufacturing systems software; or

(l) Single Object Application Protocol syntax

Preferably, the transformed delivery information includes delivery information relating to one or more of the following destinations:

(a) email addresses;

(b) facsimile numbers;

(c) postal addresses;

(d) target printers;

(e) IP addresses;

(f) system directories; or

(g) message queue.

According to a third aspect of the present invention there is disclosed a computer implemented method of transforming a source file into a transformed file using a set of trigger instructions, wherein:

the source file includes at least one data segment;

the transformed file includes at least one transformed data segment which includes the at least one data segment and structural information corresponding to that segment; and

the set of trigger instructions defines at least:

(i) the location of the data segment within the source file; and

(ii) the structural information corresponding to the segment;

and wherein the method includes the steps of

(a) applying the set of trigger instructions to the source file to:

(i) locate the data segment; and

(ii) add the structural information to the data segment to produce the transformed data segment; and

(b) storing the transformed data segment in the transformed file.

Preferably, the set of trigger instructions includes the set of trigger instructions as defined above.

Preferably, the set of trigger instructions includes data segment trigger instructions, source file type trigger instructions, function calls, statement calls, processing instructions and conditional statements.

Preferably, the source file includes a plurality of data segments contained within logical regions within the file, at least some of which are relevant data segments each having a corresponding data segment trigger instruction contained within a corresponding regional trigger group.

Preferably, the above method further includes the additional steps of repeating steps (a) and (b) until each relevant data segment has:

(i) been located; and

(ii) had structural data added to it to produce a corresponding relevant transformed data segment;

and until each of the relevant transformed data segments has been stored in the transformed file.

Preferably, there are a plurality of source files, each having a corresponding source file type.

Preferably, each source file type has a corresponding set of source file type trigger instructions, each contained in one or more trigger instructions files.

Preferably, the data segment trigger instructions include one or more of:

(i) data segment location information;

(ii) data segment structural information; or

(iii) data segment conditional information.

Preferably, the data segment location information includes one or more of:

(i) data segment position information; or (ii) data segment pattern information.

Preferably, the data segment structural information includes one or more of:

(i) data segment names;

(ii) data segment attribute settings;

(iii) data segment hierarchical positioning information; or

(iv) data segment value.

Preferably, the step of applying the set of trigger instructions to the source file to produce the transformed file is preceded by the steps of:

(a) receiving a received source file;

(b) identifying its corresponding received source file type; and

(c) identifying that source file type's corresponding set of trigger instructions.

Preferably, the step of storing the transformed data segment in the transformed file includes the step of storing each of the transformed data segments in the transformed file as they are created.

Preferably, the source file type trigger instructions include instructions relating to one or more of:

(i) transformed file delivery information;

(ii) transformed file conversion information;

(iii) transformed file encryption values;

(iv) transformed file elements;

(v) transformed file attributes;

(vi) transformed file namespaces; r

(viii) transformed file data types; or

(ix) transformed file data values.

Preferably, the source file is a relatively unstructured data file.

More preferably, the source file is a generic text data file.

Even more preferably, the source file is a print file.

Preferably, the transformed file is a relatively structured data file.

Preferably, the transformed file is an XML file.

According to a fourth aspect of the present invention there is disclosed a computer implemented system for transforming a source file into a transformed file using a set of trigger instructions, wherein:

the source file includes at least one data segment;

the transformed file includes at least one transformed data segment which includes the at least one data segment and structural information corresponding to the segment; and

the set of trigger instructions defines at least:

(i) the location of the data segment within the source file; and

(ii) the structural information corresponding to that segment;

and wherein the system:

(a) applies the set of trigger instructions to the source file to:

(i) locate the data segment; and

(ii) add the structural information to the data segment to produce the transformed data segment; and

(b) stores the transformed data segment in the transformed file.

Preferably, the set of trigger instructions includes the set of trigger instructions as defined above.

Preferably, the set of trigger instructions includes both data segment trigger instructions and source file type trigger instructions.

Preferably, the source file includes a plurality of data segments, at least some of which are relevant data segments each having a corresponding data segment trigger instruction.

Preferably, the above system repeatedly performs functions (a) and (b) until each relevant data segment has:

(iii) been located; and

(iv) had structural data added to it to produce a corresponding relevant transformed data segment; and until each of the relevant transformed data segments has been stored in the transformed file.

Preferably, there are a plurality of source files, each having a corresponding source file type.

Preferably, each source file type has a corresponding set of trigger instructions.

Preferably, the data segment trigger instructions include one or more of:

(i) data segment location information; or

(ii) data segment structural information.

Preferably, the data segment location information includes one or more of:

(i) data segment position information; or

(ii) data segment pattern information.

Preferably, the data segment structural information includes one or more of:

(i) data segment names;

(ii) data segment attribute settings; or

(iii) data segment hierarchical positioning information.

Preferably, the system applies the set of trigger instructions to the source file to produce the transformed file after it:

(a) receives a received source file;

(b) identifies its corresponding received source file type; and

(c) identifies that source file type's corresponding set of trigger instructions.

Preferably, the system stores each of the transformed data segments in the transformed file as they are created.

Preferably, the source file type trigger instructions include instructions relating to one or more of:

(i) transformed file delivery information;

(ii) transformed file conversion information;

(iii) transformed file encryption values;

(iv) transformed file elements;

(v) transformed file attributes;

(vi) transformed file namespaces;

(vii) transformed file data types; or

(viii) transformed file data values.

Preferably, the source file is a relatively unstructured data file.

More preferably, the source file is a generic text data file.

Even more preferably, the source file is a print file.

Preferably, the transformed file is a relatively structured data file.

Preferably, the transformed file is an XML file.

According to a fifth aspect of the present invention there is disclosed a computer implemented method of converting a transformed file into one or more object files and delivering the object files to one or more destinations, the transformed file including at least transformed file conversion information and transformed file delivery information, the method including the steps of:

(a) receiving the transformed file;

(b) retrieving the conversion information;

(c) converting the transformed file into the one or more object files in accordance with the conversion information;

(d) retrieving the delivery information; and

(e) delivering the one or more object files to the one or more destinations in accordance with the delivery information.

Preferably, the step of converting the transformed file into one or more object files in accordance with the conversion information includes the step of converting the transformed file into one or more object files in one or more of the following formats:

(a) XML format;

(b) facsimile format;

(c) email format;

(d) printing format;

(e) HTML format;

(f) PDF format;

(g) FTP format;

(h) EDI format;

(i) pre-printed form format;

(j) unprinted form format;

(k) an application program format; or

(l) message queue format.

Preferably, the application program format includes one or more of:

(a) word processor format;

(b) spreadsheet format;

(c) database format;

(d) accounting software format;

(e) graphic software format;

(f) invoice processing software format;

(g) Financial Management Information Systems (FMIS) software;

(h) Enterprise Resource Planning (ERP) software;

(i) Customer Resource Management systems (CRM) software;

(j) Human Resources (HR) systems software;

(k) Manufacturing systems software; or

(l) Message Queue system software.

Preferably, the destinations include one or more of:

(a) email addresses;

(b) facsimile numbers;

(c) postal addresses;

(d) target printers;

(e) IP addresses; or

(f) system directories; or

(g) message queue.

Preferably, the transformed file is a transformed file as defined in any one of the preceding paragraphs.

Preferably, the transformed file is in XML format.

According to a sixth aspect of the present invention there is disclosed a computer implemented system for converting a transformed file into one or more object files and delivering the object files to one or more destinations, the transformed file including at least transformed file conversion information and transformed file delivery information, and the system including:

(a) a receiver which receives the transformed file;

(b) a retriever which retrieves the conversion information;

(c) a converter which converts the transformed file into the one or more object files in accordance with the conversion information;

(d) a retriever which retrieves the delivery information; and

(e) a deliverer which delivers the one or more object files to the one or more destinations in accordance with the delivery information.

Preferably, the converter converts the transformed file into one or more object files in one or more of the following formats:

(a) XML format;

(b) facsimile format;

(c) email format;

(d) printing format;

(e) HTML format;

(f) PDF format;

(g) FTP format;

(h) EDI format;

(i) pre-printed form format;

(j) unprinted form format;

(k) an application program format; or

(l) message queue format.

Preferably, the application program format includes one or more of:

(a) word processor format;

(b) spreadsheet format;

(c) database format;

(d) accounting software format;

(e) invoice processing software format; or

(f) message queue software format.

Preferably, the destinations include one or more of:

(a) email addresses;

(b) facsimile numbers;

(c) postal addresses;

(d) target printers;

(e) IP addresses; or

(f) message queue.

Preferably, the transformed file is a transformed file as defined in any one of the preceding paragraphs.

Preferably, the transformed file is in XML format.

According to a seventh aspect of the invention, there is provided a computer implemented method of defining a set of trigger instructions corresponding to a source file type, the source file type including a plurality of logical data regions each containing a plurality of data segments and the method including the steps of:

(a) receiving a source file having a source file type;

(b) displaying the source file;

(c) defining logical data regions within a source file;

(d) defining regional groups of triggers that relate to a particular region;

(e) selecting data segments from a region and assigning them to a regional group; and

(f) storing that data segment trigger instruction in a trigger instruction store.

According to an eight aspect of the present invention there is provided a computer implemented method of transforming a source file into a transformed file using a set of trigger instructions, wherein:

the source file includes at least one logical data region;

the source file includes at least one data segment;

the transformed file includes at least one transformed data segment which includes the at least one data segment and structural information corresponding to that segment; and

the set of trigger instructions defines at least:

(i) the location of the data segment within the source file;

(ii) the structural information corresponding to the segment; and

(iii) the conditional statements that analyse the segments and call subsequent processing functions or statements

and wherein the method includes the steps of

(a) applying the set of trigger instructions to the source file to:

(i) locate the data segment; and

(ii) add the structural information to the data segment to produce the transformed data segment; and

(b) storing the transformed data segment in the transformed file.

### BRIEF DESCRIPTION OF DRAWINGS

A preferred embodiment of the invention will now be described, by way of example only, with reference to the accompanying drawings in which:

FIG. 1 is a block diagram of a prior art host business application commonly used by a typical small to medium sized organisation;

FIG. 2 is a block diagram of the typical software components used in prior art host business applications;

FIG. 3 is a block diagram showing the preferred embodiment of the present invention in use between a prior art host application and the example delivery mechanisms

FIG. 4 is a screen dump of an example source file which is an invoice print file;

FIG. 5 is a sample piece of XML code illustrating the annotation of invoice number “6959” with XML elements and attributes;

FIG. 6 is a screen dump of the transformed file corresponding to the source file of FIG. 4;

FIG. 7 is a block diagram of the preferred embodiment of the present invention; and

FIG. 8 is a block diagram of the preferred embodiment of the present invention, showing the XML transformation engine in combination with the XML Dynamic eXchange software.

### DESCRIPTION OF PREFERRED EMBODIMENT

The preferred embodiment of the present invention involves a computer implemented system and method of transforming a source file into a transformed file using a set of trigger instructions.

In broad overview, the present invention exploits the ubiquitous nature of generic text data and produces XML files that contain the structure, context and meaning of the data. In this way, the present invention renders the data not only human readable but also machine-readable. The resultant XML files (or “transformed files”) allow an organisation to take advantage of the advances in XML technology. One such use is to send transactional data in many ways. For example the XML based transactions may be converted to “object files” in many other formats and delivered to different trading partners in these formats. Such object files may be sent via the Internet in all web protocols that support XML. They may be sent as e-mail messages with XML data attachments. Alternatively, they may be emailed, faxed or printed in the form of dynamically created graphical renditions of business transaction forms.

The present invention provides these functions without the need for significant customising or internal changes to the original host business application. It achieves this by being able to convert relatively unstructured source files such as common dot matrix print files into highly structured, self describing transformed files such as XML files. It then takes those transformed files and, using the structured data within those files, converts the XML files into a number of formats and delivers them to a number of different destinations. The present invention therefore enables an organisation to use its current host business applications in e-commerce transactions, by simply using the present invention in place of a normal printing device.

The present invention is therefore able to convert relatively unstructured data such as a dot matrix print file or poorly structured text file, into highly structured fully described XML for use in other applications that require such structured data.

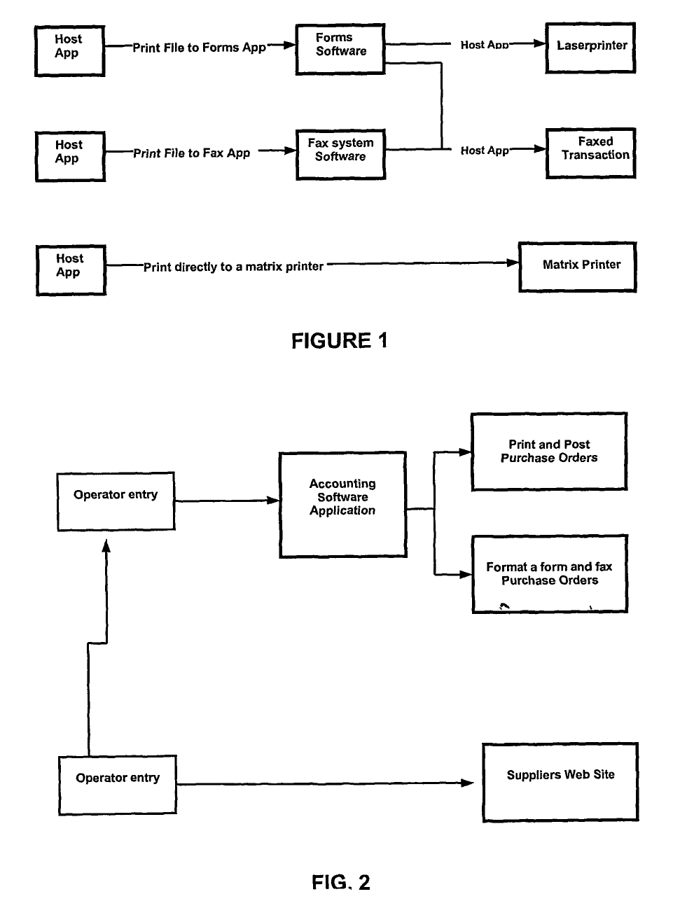

The present invention has been designed especially for use in conjunction with a host business application commonly used by a typical small to medium sized organisation. An example of such an application is illustrated in the block diagram of FIG. 1. That application includes a computer software system installed on a computer. The computer may exist as a stand-alone unit or may exist on a network of other computers. The computer typically hosts a business application that stores and generates transactions. Such application software includes but is not limited to spreadsheet software, database software, accounting software, graphics software, invoice processing software, Financial Management Information Systems (FMIS) software, Enterprise Resource Planning (ERP) software, Customer Resource Management systems (CRM) software, Human Resources (HR) systems software, or Manufacturing systems software. When a transaction occurs, such as the ordering of a product, or the issuing of an invoice, the usual method of delivering that transaction to a business partner involves a number of steps. The transaction or report is first sent to a printer. The printer then prints the report on paper. The report is then delivered via postal mail. Alternatively, it is delivered via fax.

FIG. 2 shows a schematic representation of the typical software components involved in this scenario. The host application, which in this example is an accounting software application, is used by a computer operator to enter a business transaction. Via the Accounting software a report file is prepared and sent to a software application that prepares the graphical representation of a purchase order, this application is commonly known as a Forms generation software application. The text from the report file is graphically formatted and mapped onto an electronic version of a form. The completed form is then sent to the printer or printer queue manager software for physical printing.

In such a typical scenario it will be appreciated that the source file data being transferred contains little or no structural information which describes the meaning or context of the data segments that make up the transaction. For example, when the source file is sent to a printer, all that is known from such a data stream is that text characters that appears in the file should be mapped to particular areas on the page using a particular font, as determined by the Forms Application. There is usually little or no description of the data that identifies a particular string of data as an integer, that it represents an invoice number or a customer code or that relates it to other fields on the form. Likewise, transactions sent to a computer based fax system typically only contain data segments that define the appearance of the fax message, together with a receiver's fax number. Once again the source file contains little or no self-describing structured data that describes the data making up the transaction.

Although such unstructured source file data is suitable for the printing and faxing applications described above, e-commerce and WEB based applications cannot use data in this unstructured form.

The present invention adds the required meaning, context and structure to this poorly structured data and creates a text file in XML format. The host application can then distribute this XML data to other computer systems or applications by many common transport technologies including, email, HTTP, FTP, EDI, Message Queue and the like. The present invention provides a generic set of methods and applications that enable organisations to add meaning and structure to this type of data without significant programming expertise. This has the advantage of dramatically reducing the implementation costs of making poorly structured data suitable for e-commerce, archiving and other applications.

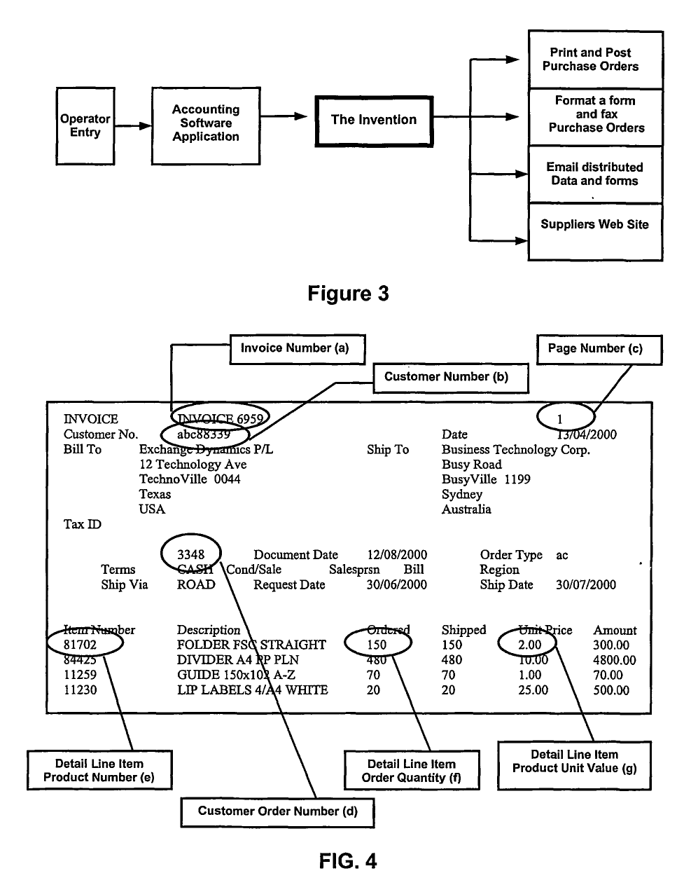

FIG. 3 shows that the preferred embodiment of the present invention fits between the Host application and the example delivery mechanisms.

In order to transform the poorly structured source file into the formats required by the various delivery mechanisms the preferred embodiment of the present invention uses a three stage process.

The first stage is the definition stage. The definition stage involves a computer implemented method of defining a set of trigger instructions corresponding to a source file type.

The second stage is the transformation stage. The transformation stage involves a computer implemented method of transforming a source file into a transformed file using a set of trigger instructions.

The third stage is the conversion stage. The conversion stage involves a computer implemented method of converting a transformed file into one or more object files in a number of different formats and delivering those object files to one or more destinations.

Beginning with the definition stage, this stage involves a computer implemented method of defining a set of trigger instructions corresponding to a source file type. The source file type includes a number of data segments grouped in logical regions and the method includes the initial step of receiving a source file which has a corresponding source file type. This source file is a relatively unstructured data file such as a generic text data file or a print file.

FIG. 4 shows a screen dump of an example source file which is an invoice print file. This invoice print file has a number of logical regions each containing data segments, some of which are circled and labelled. In this example three regions are shown, each containing data segments that include an invoice number, a customer number, a page number, a customer order number, a detail line item, a detail line item order quantity, and a detail line item product unit value. These data segments belong to logical regions on the form.

This invoice print file contains relatively unstructured data which, when printed, can be read by a human, but which, when read by a computer, does not have any real meaning. For example, all that a computer can understand from this source print file data stream is that particular text characters that appear in the file should be mapped to particular areas on the page. For example, the invoice number, number 6959 should appear in the first line of page 1, starting at column 27. The print file contains no description of the data that identifies it as an integer, that it represents an invoice number, or the like. Similarly, information sent to a computer based fax system typically only contains data that defines the appearance of the fax message and the receivers fax number. No self-describing structured data exists that describes or contains the data that makes up the fax message itself. The following example region explains the difference between unstructured, human readable data, and structured, machine readable data.

| | | |
|---|---|---|
| INVOICE | NO | 130499 |
| 1204999 | | |

A human is able to make assumptions about the above human readable data segments that normal applications software are not able to make. In this regard, the above data could mean:

a) that the invoice number is 130499;

b) that the invoice answer is “no”;

c) that the invoice number is 120499;

d) that the number 130499 means the Apr. 13, 1999;

e) that 130499 represents a delivery date;

f) that 130499 represents the current date; or

g) that 130499 represents an invoice date.

Because of the ambiguity of the above data, it is virtually useless for electronic commerce applications that must be unambiguously machine readable and interpretable.

For example, to represent invoice number 130499 in XML form, it must be annotated with XML elements and attributes. In this case, it would be:

<INVOICENUMBER>130499</INVOICENUMBER>

Once the present invention has received a source file, which in this case is an invoice print file, it displays that source file on a graphical user interface. In one embodiment the interface includes a trigger mapping tool. Once the source file is displayed in the trigger mapping tool, the invention selects one of the data segments in response to a user supplied data segment selection. In this embodiment the user supplied data segment selection is received by the user clicking on or swiping one of the data segments.

The method then involves defining a trigger instruction corresponding to the selected data segment. Defining that trigger instruction involves identifying location information corresponding to that segment and defining structural information corresponding to that segment. The location information includes data segment position information and/or data segment pattern information. An example of data segment position information can be seen with reference to customer order number 3348 in FIG. 4. In that example, the data segment position information is identified as being in the header region of the form and the “first four characters on line 9, starting from column 19”. Identifying this position information is achieved either by receiving typed positional values from a user or by extracting that information from the source file.

An example of data segment pattern information can be seen with reference to the words “INVOICE INVOICE 6959” in the top left hand corner of FIG. 4. In this example, when executing the relevant data segment trigger instruction, the data segment pattern information is evaluated by one or multiple conditions and may cause the system to search for the second occurrence of the word “INVOICE” that appears on the first line of each page of the invoice print file and then recording the next four numeric characters, which, in this case, are the numbers “6959”. In this case it was the pattern of the data segments that uniquely identified their location in the source file and it is the provision of singular or multiple conditional processing statements which allows exact determination of the data segments, regardless of their complexity.

By combining data segment position information with data segment pattern information in the triggers and the conditional evaluation of the relevant data segments, the system is able to define a wide variety of combinations of triggers which can successfully locate many different types of data segments in many different types of source files.

Advantageously, the result of conditional evaluation and processing of the data segments from positional values in regions of the source file is that source files may be successfully scanned and processed when the data segment positioning is irregular, inconsistent or incorrect. Thus when there exist programmatic anomalies in computer applications, the preferred embodiment of the invention is nevertheless able to successfully transform source data files containing data segment positional errors into meaningful structured data such as well formed XML.

This facility of regional scanning and data segment analysis according to defined conditions also allows data source files with very irregular patterns of data segments to be successfully transformed. This greatly extends the application of the preferred embodiment to many types of source files from a vast range of computer application outputs, reports, spool files or print files.

There are an effectively unlimited number of regions, data segments trigger and conditions that can be applied to any source data file, thus allowing an effectively unlimited number of alternatives to be conditionally processed when transforming a source file.

The trigger instructions operate on a number of different levels. Defining a data segment trigger instruction involves identifying location information corresponding to that data segment and defining structural information corresponding to that data segment and attaching that trigger instruction to a region instruction group, which is a group of triggers that all relate to a given area or region of a page. The data segments structural information includes data segment names, data segment attribute settings and data segment hierarchical positional information and value.

In the example of invoice number “6959” of the HEADER region in the left hand corner of FIG. 4, the trigger instruction could be defined to include structural data segment information such that when it is applied, the trigger instructs the system to add the data segment name “<INVOICENUMBER>” to the value 6959. Similarly, the data segment attribute settings which could be assigned to that data segment could be any number of XML attributes. Some possible examples are listed below.

DT:DT=“number” Identifies the Element INVOICENUMBER as a numeric only value.

FTFL=“10”.A customer attribute that, in this case, could mean a field length of 10 characters.

FTC=“B” A command used in subsequent operations by other applications.

EMAILADD=“myaddress@XML.org”

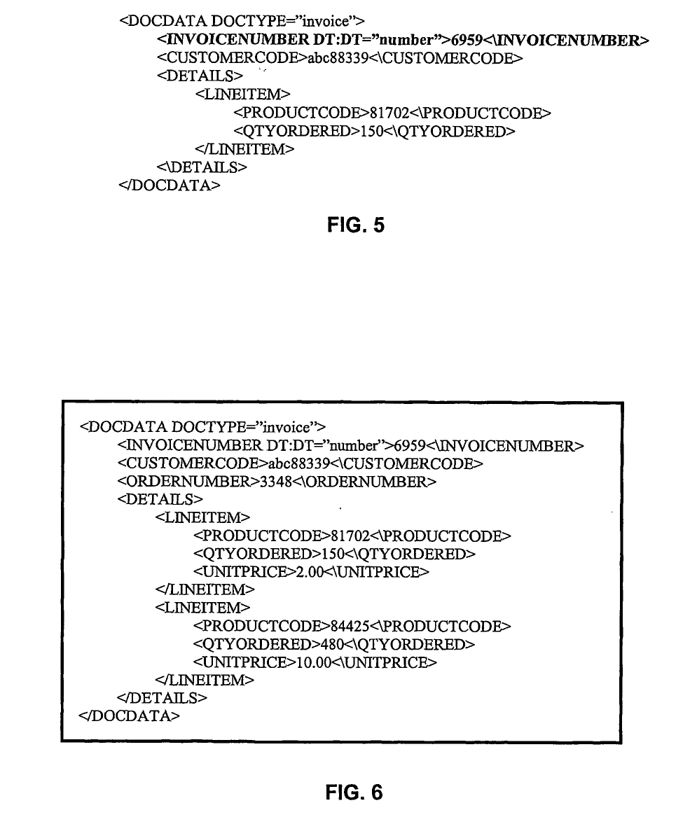

The hierarchical positioning information corresponding to data segment “6959” determines the hierarchical position of the transformed data segment which is eventually stored in the transformed file. In this example, the XML element “<INVOICENUMBER>6959</INVOICENUMBER>” is inserted as a child element of the “<DOCDATA>” element as illustrated in FIG. 5.

Once the trigger instruction corresponding to a particular data segment has been defined, including the location information and structural information corresponding to the data segment, the step of storing that trigger instruction in a trigger instruction store, such as a XML file or a database, is performed. In the preferred embodiment the trigger instructions are stored in a file having an XML structure and being grouped by region.

In one embodiment thethe trigger instruction database includes an XMD trigger instruction table, although other embodiment dispense with the requirement for this feature.

The step of defining structural information corresponding to a particular data segment could involve any number of definitional steps in order to add structure and meaning to the source file data segment. For example, to add structure to the value 6959 it may need to be related to other values within the source file. It may need to be identified with a meaningful name. Its data type and field size may need to be defined. The level of the value it occupies in the transformed XML file hierarchy must be determined, and the like.

The method of defining a set of trigger instructions corresponding to the source file type not only includes defining the region to scan and the data segment trigger instructions corresponding to particular data segments, but also includes defining source file type trigger instructions corresponding to the source file type. Such source file type trigger instructions include instructions relating to one or more of:

(i) transformed file delivery information;

(ii) transformed file conversion information;

(iii) transformed file encryption values;

(iv) transformed file elements;

(v) transformed file attributes;

(vi) transformed file namespaces;

(vii) transformed file data types; or

(viii) transformed file data types.

These source file type trigger instructions will be used during the transformation stage to store information in the transformed file which not only structures the data, but also provides information as to how the transformed file should be further dealt with in the conversion stage. For example, the transformed file delivery information indicates the final destination or destinations of the original source file, once it has been transformed. This delivery information could include destination information such as email addresses, facsimile numbers, postal addresses, target. printer locations, IP addresses, system directories and the like. It could also include other destination information such as user names and passwords of the intended recipient. Furthermore, the transformed file conversion information is used in the conversion stage and defines the formats which the transformed file should be converted into. These formats include, but are not limited to the following formats:

(a) XML format;

(b) facsimile format;

(c) email format;

(d) printing format;

(e) HTML format;

(f) PDF format;

(g) FTP format;

(h) EDI format;

(i) pre-printed form format;

(j) unprinted form format;

(k) graphic file format;

(l) an application program format; or

(m) message queue formats.

The application program format includes any format which can be successfully received and read by an application program, including but not limited to:

(a) word processor format;

(b) spreadsheet format;

(c) database format;

(f) accounting software format;

(g) graphic software format;

(h) invoice processing software format;

(g) Financial Management Information Systems (FMIS) software;

(i) Enterprise Resource Planning (ERP) software;

(j) Customer Resource Management systems (CRM) software;

(k) Human Resources (HR) systems software;

(l) Manufacturing systems software; or

(m) Message queue software.

This information is provided or added to the source file by appending data from external sources into the transformed file. When a condition is meet in the data the transformation engine will make a query on a database or other data store, retrieve relevant information and add that information to the xml structure of the transformed file. For example a trigger might return the name of a customer in an invoice, which in turn requires that customer's email address to be added to the transformed file. In this case the transformation engine will find the customer within an external data source and return the email address continued in that data store to append it to the transformed file. In this way variable data can be added to the transformed file that never existed in the source file. This information can be stored in any location within the transformed file but is typically located in the EDXSENDMETH element of the XML hierarchy.

The second stage in the method of the preferred embodiment of the present invention is the transformation stage. Normally, the definition stage will only occur once for each source file type. However, once a set of trigger instructions has been defined for a particular source file type, the transformation stage can transform any number of source files of that file type using those predefined trigger instructions.

Turning now to the second stage of the process, the transformation stage. The transformation stage involves a computer implemented method of transforming a source file into a transformed file using a set of trigger instructions. The source file is a source file as previously defined and includes at least one data segment. The transformed file is the file that results once the trigger instructions have been executed on the source file and the data segments have been given structure. The transformed file therefore includes at least one transformed data segment which includes the original data segment plus structural information, corresponding to that segment. As mentioned earlier, the data segment trigger instructions define the location of the data segments within the source file and the structural information corresponding to the data segment.

The transformation stage includes the initial step of receiving a received source file. In the example depicted in FIG. 4, the received source file is invoice number 6959's source file. Once the source file is received, the system then performs the step of identifying that source file's corresponding source file type. In this example, the source file type is an invoice print file. The system then performs the step of identifying that source file type's corresponding set of trigger instructions. In this case, the system would identify the set of invoice trigger instructions stored in one or multiple trigger instruction stores, usually in the form of one or more XML files.

Once the relevant set of trigger instructions has been located, the method then includes the step of applying that set of trigger instructions to the source file to, firstly, locate a data region then locate a data segment within the region and, secondly, add structural information to that data segment to produce the transformed data segment. After this, the method involves storing the transformed data segment in the transformed file.

Going into more detail, with reference to the source file of FIG. 4, it can be seen that the source file has a number of logical data regions, each containing data segments. At least some of the data segments within a region are relevant data segments having corresponding trigger instructions that are likewise grouped in the region trigger groups. It is envisaged that, in many applications, only some of the data segments will be relevant data segment and will therefore have corresponding trigger instructions, if the particular use dictates that a number of the data segments may be ignored.

When applying the trigger instructions to the source file, the system locates the data segment by referring to the data segment location information part of the trigger instruction. Once the data segment has been located, the data segment structural information corresponding to that data segment is then applied based on a conditional statement being met. Referring to the source file depicted in FIG. 4, part of the transformation of that source file was previously illustrated in FIG. 5. A more complete transformed file corresponding to that source file is now shown in FIG. 6.

As shown in FIG. 6, the data segment trigger instruction corresponding to the number “6959” has met certain conditional criteria and therefore caused the system to annotate that data segment with structural information. It firstly allocated the data segment name “<INVOICENUMBER>” to that data segment. It then assigned data segment attribute settings to that data segment as “DT:DT”=“number”, indicating that that particular data segment has only a numeric value. The trigger instruction also placed that data segment at the top of the hierarchical position within the transformed XML file, just below the <DOCDATA>heading.

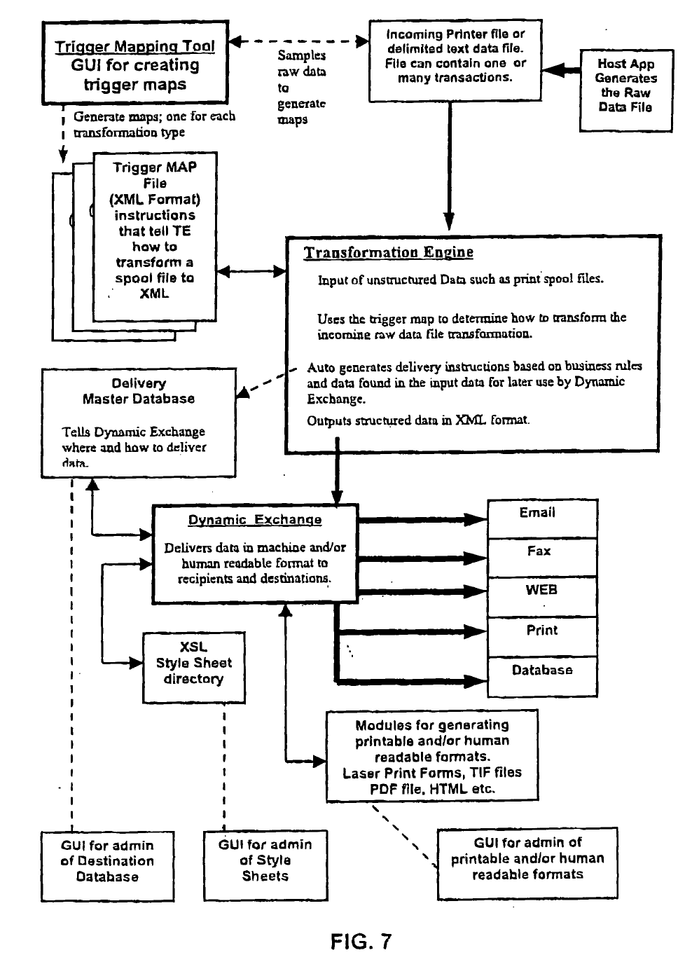

In the preferred embodiment, this transformation stage is done by a transformation engine which locates and retrieves the relevant set of trigger instructions by referring to a trigger instruction file, as illustrated in FIG. 7.

Having applied structural information to the first selected data segment, the system then begins to create the transformed file. It does this by first indicating the source file type in the transformed file. Turning to FIG. 6 the top line of information indicates that the document type (DOCTYPE) is an “invoice”.

The system then saves the transformed data segment (including the original data segment “6959” and the structural data “<INVOICENUMBER DT:DT=“number”></INVOICENUMBER>”) in the transformed file, under the DOCDATA heading.

Once the system has applied the first trigger instruction, it then goes on to apply other instructions within the same or different region trigger groups depending upon certain conditions being met until the entire source file has been transformed or until a condition is met that defines that the file transformation is complete for a particular source file.

In some instances the trigger instructions may continuously loop through the same set of trigger instructions until some condition is met that stops the looping process. For example trigger instructions 7, 8 and 9 could be repeated until a value in the data satisfies a conditional statement that calls for the loop to end whereupon another trigger (for example, trigger 10) would execute. This is useful for transforming repeating data such as the detail product lines on an invoice, and can be seen in FIG. 4 with the item numbers 81702, 84425, 11259 and 11230 in the LINE ITEMS region. The resulting XML in the transformed file seen in FIG. 6 includes these item numbers within the element names <LINEITEM>.

In the example of FIG. 6, it can be seen that the customer number “abc8839” in the top left hand cornerof the HEADER region of the source file of FIG. 4 has been given the data segment name “CUSTOMERCODE”. Although no attributes settings have been specified, that data segment has been given the hierarchical position just below the INVOICENUMBER data segment.

Similarly, customer order number “3348” found in the DETAIL region on the middle left hand side of FIG. 4 has, in FIG. 6, been given the data segment name ORDERNUMBER, and has been given the hierarchical position just below the “CUSTOMERCODE” data segment.

Also shown in FIG. 3 is a section labelled “DETAILS” which has two subsections which are entitled “LINEITEM”. As the present invention performs the transformation stage, it applies the data segment trigger instructions to the relevant data segments and extracts the details of the “PRODUCTCODE”, “QTYORDERED”, and “UNITPRICE” of each of the line items indicated in the invoice source file.

In this example, each “LINEITEM” represents a transaction. The present invention is therefore able to locate and extract a number of individual transactions from a single source file and add XML structure to them. In many applications these transactions may need to be stored in separate transformed files. Alternatively, they may all be stored in the same transformed file.

Likewise, a multi page document such as an invoice may be transformed into a single transformed file. For example, there could be 1 transformed file per invoice number, or 1 transformed file per logical document. Alternative arrangements are also envisaged.

In the preferred embodiment, each time a data segment trigger instruction is executed, the resulting transformed data segment is stored in the transformed file. In this way, as each of the set of trigger instructions is executed, the transformed XML file is incrementally created.

The preferred embodiment of the present invention also includes trigger instructions which include goto instructions. These goto instructions tell the transformation engine what to do once the current group of trigger instruction has been performed. For example, once the first trigger instruction has been performed, in which the pattern “INVOICE INVOICE 6959” has been located and annotated, the goto instruction then instructs the system to move to a new region trigger group where a trigger in that region trigger group instructs the transformation engine to move forward through the source file by 152 characters and to then execute the next trigger instruction stored in that or any other trigger group within the trigger instruction file. In this scenario, trigger instructions 2, 3 and 4 of the region trigger group named HEADER have been ignored where trigger instruction 6 of another region trigger group will execute. This flexibility allows very complex conditions to be solved for very complex source data files with multiple triggers being processed based upon conditions appearing in the data of different types of source files which have common elements.

During this transformation stage, the system not only executes data segment trigger instructions, it also executes source file type trigger instructions. These source file type trigger instructions include instructions relating to one or more of:

(i) transformed file delivery information;

(ii) transformed file conversion information;

(iii) transformed file encryption values;

(iv) transformed file elements;

(v) transformed file attributes;

(vi) transformed file namespaces;

(vii) transformed file data types; or

(viii) transformed file data values.

Although not shown in FIG. 6, the source file type trigger instructions add the above types of information into the transformed XML file, ready for the conversion stage.

Turning now to the third stage of the process, the conversion stage. In the conversion stage, the present invention involves a computer implemented method of converting a transformed file into one or more object files and delivering those object files to one or more destinations. The transformed files are highly structured files as described above and are preferably XML files. The transformed file includes at least transformed data segments, transformed file conversion information and transformed file delivery information.

The conversion stage includes the initial step of receiving the transformed file. As indicated above, the transformed file includes the transformed data segments, which not only include the original data segments from the source file but also include the structural information corresponding to those data segments. In this way, the transformed file includes self describing data. Once the system has received the transformed file it performs the step of retrieving the conversion information. The conversion information indicates the formats in which the intended recipient(s) of the transformed file, wishes to receive that file.

The system then performs the step of converting the transformed file into one or more object files in accordance with that conversion information. In this regard, the intended recipients may wish to receive the object files in one or more of the following formats:

(a) XML format;

(b) facsimile format;

(c) email format;

(d) printing format;

(e) HTML format;

(f) PDF format;

(g) FTP format;

(h) EDI format;

(i) pre-printed form format;

(j) unprinted form format;

(k) an application program format; or

(l) Single Object Application Protocol.

Because XML is so versatile, it can be readily converted into any application program format including, but not limited to, any of:

(a) word processor format;

(b) spreadsheet format;

(c) database format;

(d) accounting software format;

(e) graphic software format;

(f) invoice processing software format;

(g) Financial Management Information Systems (FMIS) software;

(h) Enterprise Resource Planning (ERP) software;

(i) Customer Resource Management systems (CRM) software;

(j) Human Resources (HR) systems software;

(k) Manufacturing systems software; or

(l) Message Queue; or

(m) Single Object Application Protocol enabled applications.

In the preferred embodiment, the step of converting transformed files into object files is done by applying XSLT style sheets to the XML data. These style sheets can convert the XML to other text based formats, and/or call other programs or scripting languages to do subsequent transformations, such as call software that converts a file to a graphic TIFF file. Therefore different style sheets can be used to do different types of conversions. The transformed files include instructions which identify the correct style sheet to apply to the particular transformed XML file. Numerous other ways of using style sheets in the conversion stage are also envisaged.

The system also performs the steps of retrieving other information from the transformed file and delivering the object file(s) to one or more destinations in accordance with the delivery information. In the preferred embodiment, the destinations include, but are not limited to:

(a) email addresses;

(b) facsimile numbers;

(c) postal addresses;

(d) target printers;

(e) IP addresses; or

(f) System directories.

In the preferred embodiment, the conversion information and delivery information are stored in the transformed file as an XML attribute called “EDXSENDMETH”.

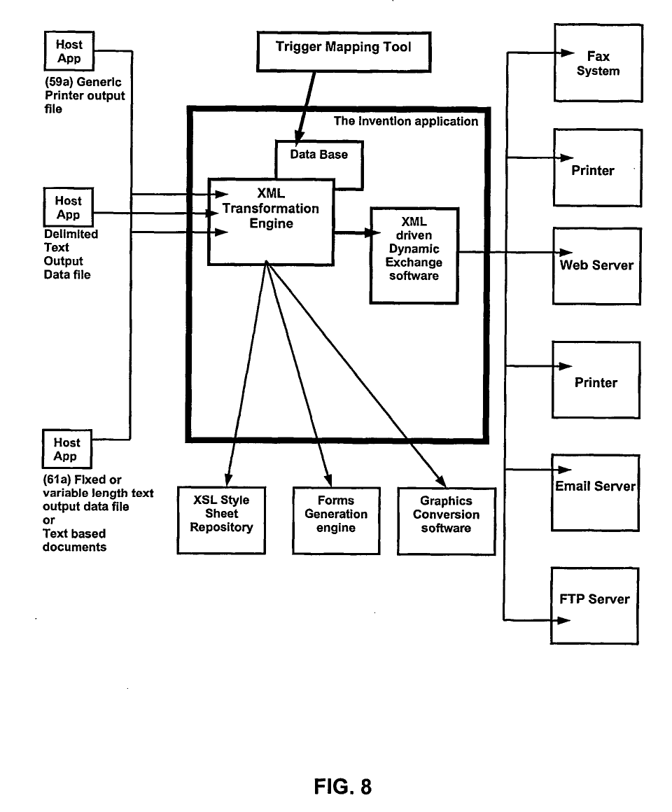

This conversion stage is preferably done by an application known as the Dynamic eXchange application, as illustrated in FIG. 8. An alternative representation can also be seen in FIG. 7.

When the EDXSENDMETH attribute is set, it is possible to for the Dynamic eXchange application to deliver a single transaction, in a transformed file, in many different formats to multiple locations, for example,

(a) an XML data file sent via FTP, Message Queue, SOAP or HTTP POST to an e-commerce workserver;

b) a TIFF file plus the XML data file sent by email to a head office;

c) a PCL print file sent to a laser printer for printing; and/or

d) a fax image of the paper copy sent to a customer via a fax system.

In this way, the Dynamic eXchange application controls all communication to delivery mechanisms such as email servers, web servers, printer queues, fax servers, file systems and FTP servers. It also controls which files are sent to which recipient by which delivery mechanism, based on the conversion information and delivery information stored in the transformed file under the EDXSENDMETH attribute of the transformed XML file.

It will be appreciated from the above description that the present invention provides a computer implemented system and method of transforming a source file into a transformed file using a set of trigger instructions. Using the three stages of definition, transformation and conversion, the present invention can simply be added on to an existing application program and allow organisations to quickly turn their old systems into e-commerce enabled systems. It does this by dynamically transforming substantially unstructured source files, such as print files, into highly structured transformed files, such as XML files, and then converting and distributing those files as required. It will be appreciated that the present invention involves a significant improvement over prior art systems and methods.

Although the invention has been described with reference to specific examples, it will be appreciated by those skilled in the art that the invention may be embodied in many other forms.

1. A computer implemented method of defining a set of trigger instructions corresponding to a source file type, the source file type including a plurality of data segments and the method including the steps of:
(a) receiving a source file having a source file type;
(b) displaying the source file;
(c) selecting one of the data segments;
(d) defining a data segment trigger instruction corresponding to that selected data segment; and
(e) storing that data segment trigger instruction in a trigger instruction store.

2. A method according to claim 1 wherein the trigger instruction store is in a file.

3. A method according to claim 1 wherein the trigger instruction store is in a database.

4. A method according to claim 1 wherein the set of trigger instructions includes data segment trigger instructions, source file type trigger instructions, function calls, statement calls, regional definitions, conditional statements, annotations and processing instructions.

5. A method according to claim 1 wherein the method further includes the additional steps of repeating steps (c) to (e) until a plurality of the data segments each have a corresponding data segment trigger instruction.

6. A method according to claim 1 wherein the step of defining the data segment trigger instruction corresponding to that selected data segment includes the steps of:
(a) identifying location information corresponding to that selected data segment; and
(b) defining structural information corresponding to that selected data segment.

7. A method according to claim 6 wherein the step of identifying location information corresponding to that selected data segment includes the step of receiving the location information from a user.

8. A method according to claim 6 wherein the step of identifying location information corresponding to that selected data segment includes the step of extracting the location information from the source file.

9. A method according to claim 6 wherein the data segment location information includes one or more of:
(i) data segment position information; or
(ii) data segment pattern information.

10. A method according to claim 1 wherein the step of selecting one of the data segments is performed in response to a user supplied data segment selection.

11. A method according to claim 6 wherein the step of defining structural information corresponding to that selected data segment includes the step of receiving the structural information from a user.

12. A method according to claim 6 wherein the structural information includes one or more of:
(i) data segment names;
(ii) data segment attribute settings; or
(iii) data segment hierarchical positioning information.

13. A method according to claim 1 wherein the step of defining a data segment trigger instruction corresponding to that selected data segment is achieved using a trigger mapping tool.

14. A method according to claim 1 wherein method further includes the additional steps of:
(a) defining source file type trigger instructions corresponding to the source file type;
(b) storing these instructions in the trigger instruction store.

15. A method according to claim 14 wherein the source file type trigger instructions include instructions relating to one or more of:
(i) transformed file delivery information;
(ii) transformed file conversion information;
(iii) transformed file encryption values;
(iv) transformed file elements;
(v) transformed file attributes;
(vi) transformed file namespaces;
(vii) transformed file data types;
(viii) transformed file data values; or
(ix) conditional statements that call other region trigger groups or triggers.

16. A method according to claim 15 wherein the transformed file conversion information includes conversion information relating to one or more of the following formats:
(a) XML format;
(b) facsimile format;
(c) email format;
(d) printing format;
(e) HTML format;
(f) PDF format;
(g) FTP format;
(h) EDI format;
(i) pre-printed form format;
(j) unprinted form format;
(k) graphic file format; or
(l) an application program format.

17. A method according to claim 16 wherein the application program format includes one or more of:
(a) word processor format;
(b) spreadsheet format;
(c) database format;
(d) accounting software format;
(e) graphic software format;
(f) invoice processing software format;
(g) Financial Management Information Systems (FMIS) software;
(h) Enterprise Resource Planning (ERP) software;
(i) Customer Resource Management systems (CRM) software;
(j) Human Resources (HR) systems software; or
(k) Manufacturing systems software.

18. A method according to claim 1 wherein the transformed delivery information includes delivery information relating to one or more of the following destinations:
(a) email addresses;
(b) facsimile numbers;
(c) postal addresses;
(d) target printers;
(e) IP addresses;
(f) system directories; or
(g) message queues.

19. A computer implemented system for defining a set of trigger instructions corresponding to a source file type, the source file type including a plurality of data segments and the system including:
(a) a receiver which receives a source file having a source file type;
(b) a display which displays the source file;
(c) a selector which selects one of the data segments;
(d) a definer which defines a data segment trigger instruction corresponding to that data segment; and
(g) storage means which stores that data segment trigger instruction in a trigger instruction store.

20. A system according to claim 18 wherein the set of trigger instructions includes data segment trigger instructions, source file type trigger instructions, function calls, statement calls, conditional statements and processing instructions.

21. A system according to claim 18 wherein system is repeatedly used until a plurality of data segments each have a corresponding data segment trigger instruction.

22. A system according to claim 18 wherein the definer, which defines the data segment trigger instruction corresponding to that selected data segment:
(a) identifies location information corresponding to that selected data segment; and
(b) defines structural information corresponding to that selected data segment.

23. A system according to claim 22 wherein the system identifies location information corresponding to that selected data segment by receiving the location information from a user.

24. A system according to claim 22 wherein the system identifies location information corresponding to that selected data segment by extracting the location information from the source file.

25. A system according to claim 22 wherein the data segment location information includes one or more of:
(i) data segment position information; or
(ii) data segment pattern information.

26. A system according to claim 18 wherein the selector selects one of the data segments in response to a user supplied data segment selection.

27. A system according to claim 18 wherein the definer defines structural information corresponding to that selected data segment by receiving the structural information from a user.

28. A system according to claim 27 wherein the structural information includes one or more of:
(i) data segment names;
(ii) data segment attribute settings;
(iii) data segment hierarchical positioning information; or
(iv) data segment value.

29. A system according to claim 28 wherein the definer is a trigger mapping tool.

30. A system according to claim 22 wherein the system:
(a) defines source file type trigger instructions corresponding to the source file type; and
(b) stores these instructions in the trigger instruction store.

31. A system according to claim 30 wherein the source file type trigger instructions include instructions relating to one or more of:
(i) transformed file delivery information;
(ii) transformed file conversion information;
(iii) transformed file encryption values;
(iv) transformed file elements;
(v) transformed file attributes;
(vi) transformed file namespaces;
(vii) transformed file data types; or (viii) transformed file data values.

32. A system according to claim 31 wherein the transformed file conversion information includes conversion information relating to one or more of the following formats:
(a) XML format;
(b) facsimile format;
(c) email format;
(d) printing format;
(e) HTML format;
(f) PDF format;
(g) FTP format;
(h) EDI format;
(i) pre-printed form format;
(j) unprinted form format;
(k) graphic file format; or
(l) an application program format.

33. A system according to claim 32 wherein the application program format includes one or more of:
(a) word processor format;
(b) spreadsheet format;
(c) database format;
(d) accounting software format;
(e) graphic software format;
(f) invoice processing software format;
(g) Financial Management Information Systems (FMIS) software;
(h) Enterprise Resource Planning (ERP) software;
(i) Customer Resource Management systems (CRM) software;
(j) Human Resources (HR) systems software;
(k) Manufacturing systems software; or
(l) Single Object Application Protocol syntax

34. A system according to claim 31 wherein the transformed delivery information includes delivery information relating to one or more of the following destinations:
(a) email addresses;
(b) facsimile numbers;
(c) postal addresses;
(d) target printers;
(e) IP addresses;
(f) system directories; or
(g) message queue.

35. A computer implemented method of transforming a source file into a transformed file using a set of trigger instructions, wherein:
the source file includes at least one data segment;
the transformed file includes at least one transformed data segment which includes the at least one data segment and structural information corresponding to that segment; and
the set of trigger instructions defines at least:
(i) the location of the data segment within the source file; and
(ii) the structural information corresponding to the segment;
and wherein the method includes the steps of
(a) applying the set of trigger instructions to the source file to:
(i) locate the data segment; and
(ii) add the structural information to the data segment to produce the transformed data segment; and
(b) storing the transformed data segment in the transformed file.

36. A method according to claim 35 wherein the set of trigger instructions includes data segment trigger instructions, source file type trigger instructions, function calls, statement calls, processing instructions and conditional statements.

37. A method according to claim 35 wherein the source file includes a plurality of data segments contained within logical regions within the file, at least some of which are relevant data segments each having a corresponding data segment trigger instruction contained within a corresponding regional trigger group.

38. A method according to claim 35 wherein the method further includes the additional steps of repeating steps (a) and (b) until each relevant data segment has:
(v) been located; and
(vi) had structural data added to it to produce a corresponding relevant transformed data segment;
and until each of the relevant transformed data segments has been stored in the transformed file.

39. A method according to claim 35 wherein there are a plurality of source files, each having a corresponding source file type.

40. A method according to claim 39 wherein each source file type has a corresponding set of source file type trigger instructions, each contained in one or more trigger instructions files.

41. A method according to claim 36 wherein the data segment trigger instructions include one or more of:
(i) data segment location information;
(ii) data segment structural information; or
(iii) data segment conditional information.

42. A method according to claim 41 wherein the data segment location information includes one or more of:
(i) data segment position information; or
(ii) data segment pattern information.

43. A method according to claim 41 wherein the data segment structural information includes one or more of:
(i) data segment names;
(ii) data segment attribute settings;
(iii) data segment hierarchical positioning information; or
(iv) data segment value.

44. A method according to claim 35 wherein the step of applying the set of trigger instructions to the source file to produce the transformed file is preceded by the steps of:
(a) receiving a received source file;
(b) identifying its corresponding received source file type; and
(c) identifying that source file type's corresponding set of trigger instructions.

45. A method according to claim 35 wherein the step of storing the transformed data segment in the transformed file includes the step of storing each of the transformed data segments in the transformed file as they are created.

46. A method according to claim 36 wherein the source file type trigger instructions include instructions relating to one or more of:
(i) transformed file delivery information;
(ii) transformed file conversion information;
(iii) transformed file encryption values;
(iv) transformed file elements;
(v) transformed file attributes;
(vi) transformed file namespaces; r (vii) transformed file data types; or (viii) transformed file data values.

47. A method according to claim 35 wherein the source file is a relatively unstructured data file.

48. A method according to claim 35 wherein the source file is a generic text data file.

49. A method according to claim 48 wherein the source file is a print file.

50. A method according to claim 35 wherein the transformed file is a relatively structured data file.

51. A method according to claim 35 wherein the transformed file is an XML file.

52. A computer implemented system for transforming a source file into a transformed file using a set of trigger instructions, wherein:
the source file includes at least one data segment;
the transformed file includes at least one transformed data segment which includes the at least one data segment and structural information corresponding to the segment; and
the set of trigger instructions defines at least:
(i) the location of the data segment within the source file; and
(ii) the structural information corresponding to that segment;
and wherein the system:
(a) applies the set of trigger instructions to the source file to:
(i) locate the data segment; and
(ii) add the structural information to the data segment to produce the transformed data segment; and
(b) stores the transformed data segment in the transformed file.

53. A system according to claim 52 wherein the set of trigger instructions includes data segment trigger instructions, source file type trigger instructions, function calls, statement calls, processing instructions and conditional statements.

54. A system according to claim 52 wherein the source file includes a plurality of data segments, at least some of which are relevant data segments each having a corresponding data segment trigger instruction.

55. A system according to claim 52 wherein the system repeatedly performs functions (a) and (b) until each relevant data segment has:
(vii) been located; and
(viii) had structural data added to it to produce a corresponding relevant transformed data segment;
and until each of the relevant transformed data segments has been stored in the transformed file.

56. A system according to claim 52 wherein there are a plurality of source files, each having a corresponding source file type.

57. A system according to claim 56 wherein each source file type has a corresponding set of trigger instructions.

58. A system according to claim 53 wherein the data segment trigger instructions include one or more of:
(i) data segment location information; or
(ii) data segment structural information.

59. A system according to claim 58 wherein the data segment location information includes one or more of:
(i) data segment position information; or
(ii) data segment pattern information.

60. A system according to claim 58 or 59 wherein the data segment structural information includes one or more of:
(i) data segment names;
(ii) data segment attribute settings; or
(iii) data segment hierarchical positioning information.

61. A system according to claim 52 wherein the system applies the set of trigger instructions to the source file to produce the transformed file after it:
(a) receives a received source file;
(b) identifies its corresponding received source file type; and
(c) identifies that source file type's corresponding set of trigger instructions.

62. A system according to claim 52 wherein the system stores each of the transformed data segments in the transformed file as they are created.

63. A system according to claim 53 wherein the source file type trigger instructions include instructions relating to one or more of:
(i) transformed file delivery information;
(ii) transformed file conversion information;
(iii) transformed file encryption values;
(iv) transformed file elements;
(v) transformed file attributes;
(vi) transformed file namespaces;
(vii) transformed file data types; or
(viii) transformed file data values.

64. A system according to claim 52 wherein the source file is a relatively unstructured data file.

65. A system according to claim 52 wherein the source file is a generic text data file.

66. A system according to claim 65 wherein the source file is a print file.

67. A system according to claim 52 wherein the transformed file is a relatively structured data file.

68. A system according to claim 52 wherein the transformed file is an XML file.

69. A computer implemented method of converting a transformed file into one or more object files and delivering the object files to one or more destinations, the transformed file including at least transformed file conversion information and transformed file delivery information, the method including the steps of:
(a) receiving the transformed file;
(b) retrieving the conversion information;
(c) converting the transformed file into the one or more object files in accordance with the conversion information;
(d) retrieving the delivery information; and
(e) delivering the one or more object files to the one or more destinations in accordance with the delivery information.

70. A method according to claim 69 wherein the step of converting the transformed file into one or more object files in accordance with the conversion information includes the step of converting the transformed file into one or more object files in one or more of the following formats:
(a) XML format;
(b) facsimile format;
(c) email format;
(d) printing format;
(e) HTML format;
(f) PDF format;
(g) FTP format;
(h) EDI format;
(i) pre-printed form format;
(j) unprinted form format; r
(k) an application program format; or
(l) message queue format.

71. A method according to claim 70 wherein the application program format includes one or more of:
(m) word processor format;
(n) spreadsheet format;
(o) database format;
(p) accounting software format;
(q) graphic software format;
(r) invoice processing software format;
(s) Financial Management Information Systems (FMIS) software;
(t) Enterprise Resource Planning (ERP) software;
(u) Customer Resource Management systems (CRM) software;
(v) Human Resources (HR) systems software;
(w) Manufacturing systems software; or
(x) Message Queue system software.

72. A method according to claim 69 wherein the destinations include one or more of:
(a) email addresses;
(b) facsimile numbers;
(c) postal addresses;
(d) target printers;
(e) IP addresses; or
(f) system directories; or
(g) message queue.

73. A method according to claim 69 wherein the transformed file is a relatively structured data file.

74. A method according to claim 69 wherein the transformed file is in XML format.

75. A computer implemented system for converting a transformed file into one or more object files and delivering the object files to one or more destinations, the transformed file including at least transformed file conversion information and transformed file delivery information, and the system including:
(a) a receiver which receives the transformed file;
(b) a retriever which retrieves the conversion information;
(c a converter which converts the transformed file into the one or more object files in accordance with the conversion information;
(d) a retriever which retrieves the delivery information; and
(e) a deliverer which delivers the one or more object files to the one or more destinations in accordance with the delivery information.

76. A system according to claim 75 wherein the converter converts the transformed file into one or more object files in one or more of the following formats:
(a) XML format;
(b) facsimile format;
(c) email format;
(d) printing format;
(e) HTML format;
(f) PDF format;
(g) FTP format;
(h) EDI format;
(i) pre-printed form format;
(j) unprinted form format;
(k) an application program format; or
(l) message queue format.

77. A system according to claim 76 wherein the application program format includes one or more of:
(a) word processor format;
(b) spreadsheet format;
(c) database format;
(d) accounting software format;
(e) invoice processing software format; or
(f) message queue software format.

78. A system according to claim 75 wherein the destinations include one or more of:
(a) email addresses;
(b) facsimile numbers;
(c) postal addresses;
(d) target printers;
(e) IP addresses; or
(f) message queue.

79. A system according to claim 75 wherein the transformed file is a relatively structured file.

80. A system according to claim 75 wherein the transformed file is in XML format.

81. A computer implemented method of defining a set of trigger instructions corresponding to a source file type, the source file type including a plurality of logical data regions each containing a plurality of data segments and the method including the steps of:
(a) receiving a source file having a source file type;
(b) displaying the source file;
(c) defining logical data regions within a source file;
(d) defining regional groups of triggers that relate to a particular region;
(e) selecting data segments from a region and assigning them to a regional group; and
(f) storing that data segment trigger instruction in a trigger instruction store.

82. A computer implemented method of transforming a source file into a transformed file using a set of trigger instructions, wherein:
the source file includes at least one logical data region;
the source file includes at least one data segment;
the transformed file includes at least one transformed data segment which includes the at least one data segment and structural information corresponding to that segment; and
the set of trigger instructions defines at least:
(i) the location of the data segment within the source file;
